(19) United States
(12) Patent Application Publication
(10) Pub. No.: US 2007/0006086 A1
(43) Pub. Date: Jan. 4, 2007

(54) Method of browsing application views, electronic device, graphical user interface and computer program product

(76) Inventors: Petri Kokko, Oulu (FI); Markku Rytivaara, Oulu (FI); Harry Storbacka, Smabonders (FI)

Correspondence Address: Hollingsworth & Funk, LLC, Suite 125, 8009 34th Avenue South, Minneapolis, MN, 55425, US

(21) Appl. No.: 11/171,946

(22) Filed: Jun. 30, 2005

(51) Int. Cl. G06F 17/00

(52) U.S. Cl. 715/760

(57) ABSTRACT

The invention relates to a method of browsing application views in an electronic device, to an electronic device, to a graphical user interface, and to a computer program product. The electronic device is configured to: display an initial application view on the display; provide a browse control area displayed on the display, the browse control area comprising a zooming block for controlling software functions for zooming; detect a drag function on the zooming block; perform software functions for zooming in response to the drag function detected on the zooming block; display a current application view on the basis of the performed software functions for zooming; and display a whole application view on the browse control area.

### BACKGROUND OF THE INVENTION

1. Field of the Invention

The invention relates to a method of browsing application views in an electronic device, to an electronic device, to a graphical user interface for browsing application views shown on a display of an electronic device, and to a computer program product.

2. Description of the Related Art

The significance of different displays, such as, touch screens, is becoming more and more important in portable electronic devices. The browsing capabilities of these devices are improving. Portable devices are more and more used when browsing different application views shown in the devices, for example. Browsing on the Internet is one example of where the usability of a display is critical. However, the sizes of different portable electronic devices are limited, and therefore also the sizes of the displays used in such devices are usually far smaller than those of corresponding displays used in personal computers, for example. Due to the limited sizes of the displays, the users need to zoom and scroll a lot when navigating on the Internet, for example.

In known systems, the functions of zooming in and out, for example, are usually quite difficult to use. When zooming in to or out of an Internet document, for example, the user may have great difficulties in keeping track of the whole picture of the zoomed document. Especially in small sized displays, improvements to browsing capabilities of the electronic devices are highly needed.

### SUMMARY OF THE INVENTION

The object of the invention is to provide an improved method of browsing application views in an electronic device, an improved electronic device, a graphical user interface, and a computer program product.

According to an aspect of the invention, there is provided a method of browsing application views in an electronic device, the electronic device comprising a display for showing application views and an input device. The method comprises displaying an initial application view on the display; providing a browse control area displayed on the display, the browse control area comprising a zooming block for controlling software functions for zooming; detecting a drag function on the zooming block; performing software functions for zooming in response to the drag function detected on the zooming block; displaying a current application view on the basis of the performed software functions for zooming; and displaying a whole application view on the browse control area.

According to another aspect of the invention, there is provided an electronic device comprising a processing unit for controlling functions of the electronic device, a display coupled to the processing unit for showing application views, and an input device for giving control commands for browsing application views. The processing unit is configured to: display an initial application view on the display; provide a browse control area displayed on the display, the browse control area comprising a zooming block for controlling software functions for zooming; detect a drag function on the zooming block; perform software functions for zooming in response to the drag function detected on the zooming block; display a current application view on the basis of the software functions performed for zooming; and display a whole application view on the browse control area.

According to an embodiment of the invention, there is provided a graphical user interface for browsing application views shown on a display of an electronic device, the graphical user interface comprising: an initial application view displayed on the display; a browse control area displayed on the display, the browse control area comprising a zooming block for controlling software functions for zooming; a current application view displayed on the display on the basis of software functions performed for zooming in response to a detected drag function on the zooming block; and a whole application view displayed on the browse control area.

According to another embodiment of the invention, there is provided a computer program product encoding a computer process for providing browsing application views in an electronic device. The computer process comprising: displaying an initial application view on the display; providing a browse control area displayed on the display, the browse control area comprising a zooming block for controlling software functions for zooming; detecting a drag function on the zooming block; performing software functions for zooming in response to the drag function detected on the zooming block; displaying a current application view on the basis of the performed software functions for zooming; and displaying a whole application view on the browse control area.

According to an embodiment of the invention, there is provided an electronic device, comprising processing means for controlling functions of the electronic device, display means for showing application views, and input means for giving control commands for browsing application views, the electronic device further comprising: display means for displaying an initial application view on the display; providing means for providing a browse control area displayed on the display, the browse control area comprising a zooming block for controlling software functions for zooming; detection means for detecting a drag function on the zooming block; software function performing means for performing software functions for zooming in response to the drag function detected on the zooming block; display means for displaying a current application view on the basis of the performed software functions for zooming; and display means for displaying a whole application view on the browse control area.

The embodiments of the invention provide several advantages. Application views can be zoomed using a simple tool. Space is saved in the display of the portable electronic device. From the point of view of the user, it is easier to keep track of the whole picture of the application view while zooming. Further, the invention is quickly understandable and easy to learn and use.

### BRIEF DESCRIPTION OF THE DRAWINGS

In the following, the invention will be described in greater detail with reference to preferred embodiments and the accompanying drawings, in which

FIG. 1 shows an example of an electronic device;

FIGS. 2A and 2B illustrate examples of user interfaces of the invention;

FIG. 3 shows an example of a method of browsing in application views in a user interface of an electronic device; and

FIG. 4 shows another example of a method of browsing in application views.

### DETAILED DESCRIPTION OF THE PREFERRED EMBODIMENTS

The embodiments of the invention are applicable to electronic devices, such as mobile stations used as terminals in telecommunication systems comprising one or more base stations and terminals communicating with the base stations, for example. The devices may be used for short-range communication implemented with a Bluetooth chip, or an infrared or WLAN connection, for example. The electronic device is, for example, a portable telephone or some other device including telecommunication means, such as a portable computer, a personal computer, a handheld computer or a smart telephone. The portable electronic device may be a PDA (Personal Digital Assistant) device including the necessary telecommunication means for establishing a network connection, or a PDA device that can be coupled to a mobile telephone, for instance, for a network connection. The portable electronic device may also be a computer or PDA device including no telecommunication means.

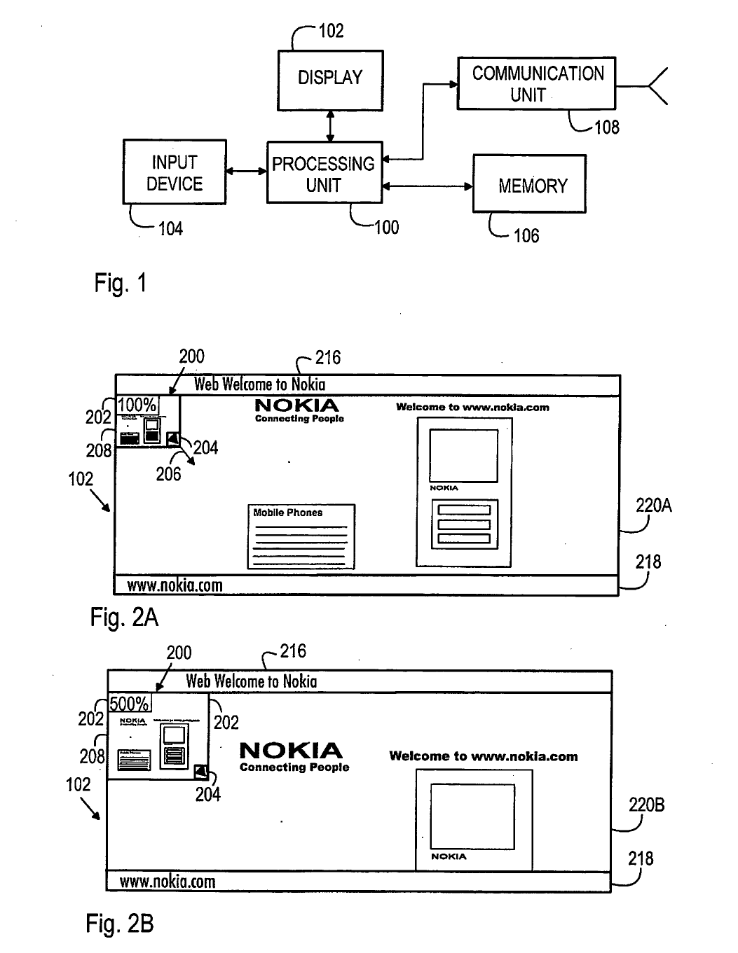

FIG. 1 shows a block diagram of the structure of an electronic device. A processing unit 100, typically implemented by means of a microprocessor and software or separate components, controls the basic functions of the device. A user interface of the device comprises an input device 104 and a display 102, such as a touch screen implemented by manners known per se. In addition, the user interface of the device may include a loudspeaker and a keypad part. The parts of the user interface and their number may vary, depending on the type of the device. The device of FIG. 1, such as a mobile station, may also include communication means 108 that implement the functions of a mobile station and include speech and channel coders, modulators and RF parts. The device may also comprise an antenna and a memory 106.

The functions of the device are controlled by means of the input device 104, such as a mouse, a hand-held locator operated by moving it on a surface. When using a mouse, for example, a sign or a symbol shows the location of a mouse cursor on the display 102 and often also the function running in the device, or its state. It is also possible that the display 102 itself is the input device 104 implemented by means of a touch screen such that the desired functions are selected by touching the desired objects visible on the display 102. A touch on the display 102 may be carried out by means of a pen, a stylus or a finger, for example. The input device 104 can also be implemented by using eye tracking means where detection of eye movements is used in interpreting certain control commands.

The processing unit 100 controls the functions of the user interface and is connected to the display 102 and configured to show different application views on the display 102. The processing unit 100 receives control commands from the input device 104. The input device 104 is configured to give control commands for browsing in application views shown on the display 102. The application views may be views into different web pages on the Internet, views from any application programs run in the device or any other application views that may be shown on the display 102. The navigating or browsing of the application views may include scrolling the application view in any direction, for example horizontally or vertically, zooming in on the application view to get a better view of the details of the application view or zooming out on the application view to get a more general view of the whole application view.

The browsing functions operate such that the desired functions, such as scrolling or zooming, are first selected by means of the input device 104. Then, the processing unit 100 interprets the detected selections, performs given software functions based thereon and, as a result of the performed software functions, displays a given application view on the display 104.

In an embodiment of the invention, the processing unit 100 first displays an initial application view on the display 102. The displayed initial application view may be a view to an Internet page or to a document, for example. The displayed initial application view may be the whole view of the page/document or a view to at least part of the page/document.

The processing unit 100 is configured to provide a browse control area displayed on the display, the browse control area comprising a zooming block for controlling software functions for zooming. The processing unit 100 is then configured to detect a drag function on the zooming block. The drag function may be detected on the basis of a touch on the display 102, for example. Alternatively, the drag function may be detected by means of the input device 104, such as a mouse or a pen. Based on the detected drag function on the zooming block the processing unit 100 is configured to perform software functions for zooming and to display a current application view on the basis of the software functions performed for zooming. Further, the processing unit 100 is configured to display a whole application view on the browse control area.

The initial application view may be a whole or a partial view into an Internet page, and the current application view after the zooming function may be a view into another part of the Internet page, for example.

The processing unit 100 continues to detect control commands indicated by the input device 102 and to detect drag functions on the zooming block. It is possible that each time a browser application is opened the browse control area is also provided on the display. It is also possible that the browse control area is opened separately by using an icon or a menu function or by tap-based activation.

Let us next study embodiments of the invention by means of FIGS. 2A and 2B. FIGS. 2A and 2B show displays 104 of an electronic device. FIGS. 2A and 2B illustrate graphical user interfaces in an embodiment of the invention.

A display 102 is usually divided into different areas, each area having specific functions. Application views are shown in the largest areas 220A and 220B, for example. There may also be different bars 216, 218 for displaying different information or menus on the display 102.

In an embodiment there is provided a browse control area 200 displayed on the display 102. In an embodiment the browse control area 200 may be located at least partly on the application view on the display. The browse control area 200 comprises a zooming block 204 for controlling software functions for zooming. The browse control area 200 and the zooming block 204 may also be of any other shape than that of a square, such as a circle, for example.

In FIG. 2A, an initial application view is displayed on the display 220A. In this example, the initial application view comprises the whole application view, for example the whole page of an Internet document. The initial application view may also be at least part of the whole application view. A whole application view is also displayed in the browse control area 200.

When a user wishes to zoom in or out on the initial application view, he/she may select the zooming block 204 and drag it. A current application view is then displayed on the display on the basis of software functions performed for zooming in response to a detected drag function on the zooming block 204. In an embodiment, also the size of the browse control area 200 is adjusted on the basis of the detected drag function on the zooming block 204. For example, when the zooming block 204 of FIG. 2A is dragged in the direction of the arrow 206, the size of the browse control area 200 is increased. FIG. 2B shows that the size of the browse control area 200 has increased after the zooming block 204 has been dragged.

The software functions for zooming are performed on the basis of at least one of the following: the amount of the detected drag function, the speed of the detected drag function, the direction of the detected drag function. In the example of FIGS. 2A and 2B, the dragging of the zooming block 204 produces a zooming-in function on the initial application view. As a result, as seen in FIG. 2B, a zoomed-in application view of the initial application view is provided.

Starting from a situation shown in FIG. 2B, a zooming-out of an initial application view of FIG. 2B can be carried out by dragging the zooming block 204 of FIG. 2B in the inverse direction than above. Thus, the size of the browse control area 200 is decreased back to that of the area in FIG. 2A, and at the same time, the application view is zoomed out.

As the whole application view is displayed on the largest area 208 of the browse control area 200, it is easy to maintain a general view of the whole zoomed document while zooming in or out. It is possible that the whole application view is displayed on the browse control area 200 only when a zoomed in application view on the basis of the software functions performed for zooming is displayed. The whole application view may also be displayed at all times on the largest area 208 of the browse control area 200.

In an embodiment, an indication block 202 is provided in the browse control area 200 for indicating the amount of current zooming. For example, in FIG. 2A, the indication block 202 indicates that 100% zooming of the application view is effective i.e. no zooming has been directed at the application view. In FIG. 2B, the indication block 202 indicates that 500% zooming of the application view is effective i.e. the application view has been zoomed in fivefold. There may also be other ways to indicate the amount of current zooming than that of the examples of FIGS. 2A and 2B.

In an embodiment, a drag function on the indication block 202 can be detected, and software functions for scrolling the initial application view to produce a current application view can be performed on the basis of the detected drag function on the indication block 202. FIG. 2B, for example, illustrates a situation in which a user may wish to maintain the amount of zooming at 500% but at the same time needs to view another part of the application view, for example a lower part of the application view. Thus, by dragging the indication block 202 downwards to a desired location in the browse control area 200, the application view is scrolled down and a view to the lower part of application view is produced. It is thus possible to scroll easily to any part of the application view by dragging the indication block 202 in the browse control area 200. The direction of drag may define the scrolling direction. Dragging the indication block 202 down results in showing more content below the current view. A page may be scrolled in any direction. The scrolling direction may be the same as a current angle between a scroll starting point and a stylus, for example.

There may also be other control blocks in the browse control area 200 than those given in these examples.

The zooming block 204 and the indication block 202 may be dragged using an input device. For example, tapping on the desired block and holding a pen down while dragging the block may move the block to a desired location. The input device may be a touch screen and a stylus, for example, and the user may select the zooming block 204 by first touching the touch screen with the stylus. The stylus may then be moved along the surface of the touch screen to produce a dragging function associated with the selected zooming block 204. Thus the software functions associated with the selected block are performed on the basis of the drag function detected on the block. In an embodiment, the software functions performed are based on the amount of the drag function detected on the zooming block 204. In another embodiment, the software functions performed are based on the speed of the drag function detected on the zooming block 204. Thus, the direction and the length of the drag function may define attributes for the software functions. The software functions may be accelerated if the block is dragged farther away from the original point. The direction of the drag defines whether the view is zoomed in or out. Dragging to the right or up may zoom in, and dragging to the left or down may zoom out, for example.

The appearance of the browse control area 200, zooming block 204 and the indication block 202 may be set as desired. Appropriate colors, text, drawings or fill effects may be used to mark the blocks.

The browse control area 200, zooming block 204 and the indication block 202 may also be set to appear in a “ghost mode”, meaning for example that only essential elements, such as outlines of the blocks, are used to indicate different blocks. The whole browse control area 200 may also be semi-transparent, that is, the contents below the browse control area 200 are visible. The level of transparency may also be adjusted. Thus, the browse control area 200 does not cover so much of the application view shown on the display 102.

The location and size of browse control area 200 may be determined by using the user interface of the device, for example. It is possible that each time an application view is opened, the browse control area 200 is displayed in a given location, for example in the upper left corner of the display 102. The browse control area 200 may also be located on the different bars 216, 218 for displaying different information or in the largest area 220A, 220B of the display. The location of the browse control area 200 may also be changed at any time. The size of the browse control area 200 may also be set according to the needs of individual users of the device, for example. The user may choose between a large and a small browse control area 200, for example.

New ways of browsing application views efficiently with the browse control area was shown in the previous examples. Because of screen space limitations, for example, mobile Web users wish to utilize the full screen when viewing a Web page. It is essential to provide the users a full screen mode in which browser controls or large scroll bars do not cover the page content. Still, the most important browse control blocks should be easily accessible. The examples shown provide possibilities to steplessly zoom or scroll the application views with a single gesture of a stylus, for example.

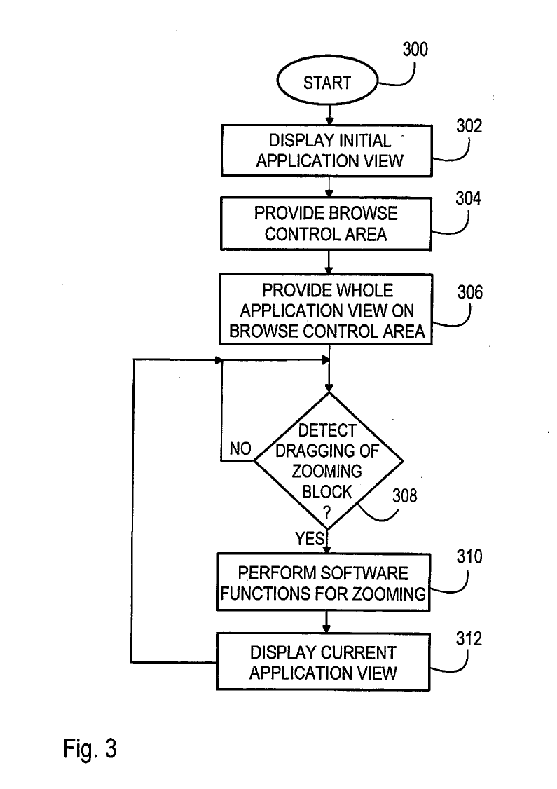

FIG. 3 shows an example of a method of browsing in application views in a user interface of an electronic device.

The method starts at 300. In 302, an initial application view is displayed on the display. In 304, a browse control area is displayed on the display. The browse control area may be displayed automatically when the application view is shown on the display, for example. It is also possible that the browse control area is first shown as an icon on the display, then activated from a menu or on the basis of a tap-based activation on screen and selected when needed. The browse control area comprises a zooming block for controlling software functions for zooming. In 306, the whole application view is provided on the browse control area. In 308, if dragging of the zooming block is detected, 310 is entered. If dragging of the zooming block is not detected, the initial application view remains with the browse control area displayed on the display.

In 310, software functions associated with the zooming block are performed based on the detection of the dragging of the zooming block. In 312, a current application view is displayed based on the performed software functions. The method may continue by repeating of the steps from 308 to 312 until the application is closed, another function is selected, or the device is shut down.

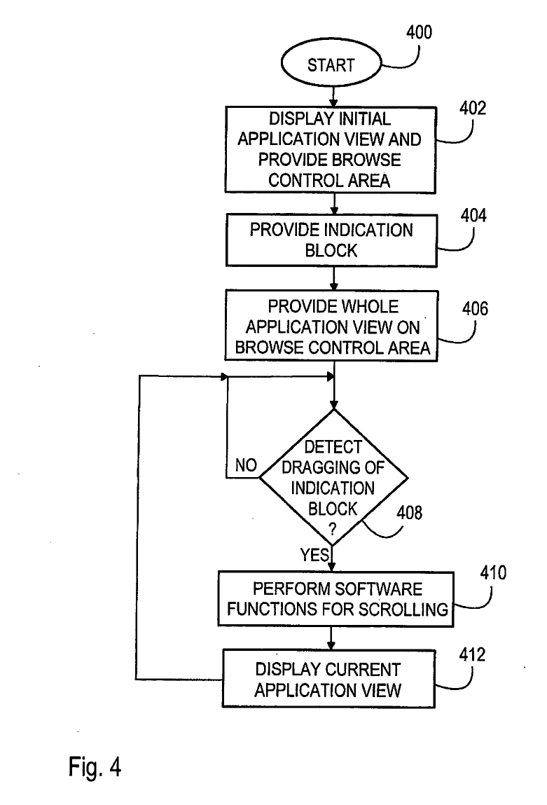

FIG. 4 shows another example of a method of browsing in application views. The method starts in 400. In 402, an initial application view is displayed and a browse control area is provided. In 404, an indication block is provided in the browse control area. In 406, the whole application view is displayed on the browse control area.

In 408, if dragging of the indication block is detected, then 410 is entered. If dragging of the indication block is not detected, the initial application view remains. In 410, software functions for scrolling are performed on the basis of the detection of dragging of the indication block. In 412, a current application view is displayed on the basis of the performed software functions. The method may continue by repeating of the steps from 408 to 412 until the application is closed, another function is selected or the device is shut down.

The embodiments of the invention may be implemented in an electronic device comprising a processing unit operationally connected to an input device, for example. The processing unit may be configured to perform at least some of the steps described in connection with the flowcharts of FIGS. 3 and 4. The embodiments may be implemented as a computer program comprising instructions for executing a computer process for browsing application views in an electronic device.

The computer program may be stored on a computer program distribution medium readable by a computer or a processor. The computer program medium may be, for example but not limited to, an electric, magnetic, optical, infrared or semiconductor system, device or transmission medium. The medium may be a computer readable medium, a program storage medium, a record medium, a computer readable memory, a random access memory, an erasable programmable read-only memory, a computer readable software distribution package, a computer readable signal, a computer readable telecommunications signal, and a computer readable compressed software package.

Even though the invention has been described above with reference to an example according to the accompanying drawings, it is clear that the invention is not restricted thereto but can be modified in several ways within the scope of the appended claims.

1. A method of browsing application views in an electronic device, the electronic device comprising a display for showing application views and an input device, the method comprising:
displaying an initial application view on the display;
providing a browse control area displayed on the display, the browse control area comprising a zooming block for controlling software functions for zooming;
detecting a drag function on the zooming block;
performing software functions for zooming in response to the drag function detected on the zooming block;
displaying a current application view on the basis of the performed software functions for zooming; and
displaying a whole application view on the browse control area.

2. The method of claim 1, the method further comprising providing an indication block in the browse control area for indicating the amount of current zooming.

3. The method of claim 2, the method further comprising detecting a drag function on the indication block; and performing software functions for scrolling the initial application view to produce a current application view on the basis of the drag function detected on the indication block.

4. The method of claim 1, wherein the step of performing software functions for zooming comprises zooming in or out on the initial application view to produce the current application view.

5. The method of claim 1, wherein the input device comprises a touch screen and the step of detecting the drag function on the zooming block is based on indications detected from the touch screen.

6. The method of claim 1, wherein the step of performing the software functions for zooming is based on at least one of the following: the amount of the detected drag function, the speed of the detected drag function, the direction of the detected drag function.

7. The method of claim 1, wherein the step of providing the initial application view comprises displaying at least part of the whole application view on the display.

8. The method of claim 1, the method further comprising displaying the whole application view on the browse control area when the current application view on the basis of the software functions performed for zooming is displayed.

9. The method of claim 1, the method further comprising adjusting the size of the browse control area on the basis of the drag function detected on the zooming block.

10. An electronic device, comprising a processing unit for controlling functions of the electronic device, a display coupled to the processing unit for showing application views, and an input device for giving control commands for browsing application views, the processing unit being configured to:
display an initial application view on the display;
provide a browse control area displayed on the display, the browse control area comprising a zooming block for controlling software functions for zooming;
detect a drag function on the zooming block;
perform software functions for zooming in response to the drag function detected on the zooming block;
display a current application view on the basis of the software functions performed for zooming; and
display a whole application view on the browse control area.

11. The electronic device of claim 10, wherein the processing unit is further configured to provide an indication block in the browse control area for indicating the amount of current zooming.

12. The electronic device of claim 11, wherein the processing unit is further configured to detect a drag function on the indication block; and to perform software functions for scrolling the initial application view to produce a current application view on the basis of the drag function detected on the indication block.

13. The electronic device of claim 10, wherein the processing unit is further configured to provide the browse control area when the initial application view is opened in the display.

14. The electronic device of claim 10, wherein the processing unit is configured to perform the software functions for zooming by zooming in or out on the initial application view to produce the current application view.

15. The electronic device of claim 10, wherein the input device comprises a touch screen and the step of detecting the drag function on the zooming block is based on indications detected from the touch screen.

16. The electronic device of claim 10, wherein the processing unit is configured to perform the software functions for zooming on the basis of at least one of the following: the amount of the detected drag function, the speed of the detected drag function, the direction of the detected drag function.

17. The electronic device of claim 10, wherein the processing unit is configured to provide the initial application view by displaying at least part of the whole application view on the display.

18. The electronic device of claim 10, wherein the processing unit is configured to display the whole application view on the browse control area when the current application view on the basis of the software functions performed for zooming is displayed.

19. The electronic device of claim 10, wherein the processing unit is configured to adjust the size of the browse control area on the basis of the drag function detected on the zooming block.

20. A graphical user interface for browsing application views shown on a display of an electronic device, the graphical user interface comprising:
an initial application view displayed on the display;
a browse control area displayed on the display, the browse control area comprising a zooming block for controlling software functions for zooming;
a current application view displayed on the display on the basis of software functions performed for zooming in response to a detected drag function on the zooming block; and
a whole application view displayed on the browse control area.

21. The graphical user interface of claim 20, further comprising an indication block in the browse control area for indicating the amount of current zooming.

22. The graphical user interface of claim 21, further comprising a current application view displayed on the display on the basis of software functions performed for scrolling associated with a drag function detected on the indication block.

23. The graphical user interface of claim 20, wherein the current application view is produced by the software functions zooming in or out on the initial application view.

24. The graphical user interface of claim 20, wherein the initial application view comprises at least part of the whole application view.

25. The graphical user interface of claim 20, wherein the whole application view is displayed on the browse control area when the current application view on the basis of the software functions performed for zooming is displayed.

26. A computer program product encoding a computer process for providing browsing application views in an electronic device, the computer process comprising:
displaying an initial application view on the display;
providing a browse control area displayed on the display, the browse control area comprising a zooming block for controlling software functions for zooming;
detecting a drag function on the zooming block;
performing software functions for zooming in response to the drag function detected on the zooming block;
displaying a current application view on the basis of the software functions performed for zooming; and
displaying a whole application view on the browse control area.

27. The computer program product of claim 26, the computer process further performing the functions of providing an indication block in the browse control area for indicating the amount of current zooming, and performing software functions for scrolling the initial application view to produce a current application view on the basis of drag function detected on the indication block.

28. The computer program product of claim 26, further performing the functions of displaying the whole application view on the browse control area when the current application view on the basis of the software functions performed for zooming is displayed on the display.

29. An electronic device, comprising processing means for controlling functions of the electronic device, display means for showing application views, and input means for giving control commands for browsing application views, the electronic device further comprising:
display means for displaying an initial application view on the display;
providing means for providing a browse control area displayed on the display, the browse control area comprising a zooming block for controlling software functions for zooming;
detection means for detecting a drag function on the zooming block;
software function performing means for performing software functions for zooming in response to the drag function detected on the zooming block;
display means for displaying a current application view on the basis of the performed software functions for zooming; and
display means for displaying a whole application view on the browse control area.
